(19) United States
(12) Patent Application Publication
(10) Pub. No.: US 2026/0057317 A1
(43) Pub. Date: Feb. 26, 2026

(54) EFFICIENTLY SOLVING PARTIALLY ORDERED TOP-QUALITY PLANNING

(71) Applicant: International Business Machines Corporation, Armonk, NY (US)

(72) Inventors: Michael Katz, Goldens Bridge, NY (US); Junkyu Lee, San Diego, CA (US); Shirin Sohrabi Araghi, Briarcliff manor, NY (US); Jung Koo Kang, Wakefield, MA (US)

(21) Appl. No.: 18/810,932

(22) Filed: Aug. 21, 2024

(51) Int. Cl. G06Q 10/0631; G06Q 10/0637

(52) U.S. Cl. CPC G06Q 10/06313; G06Q 10/0637

(57) ABSTRACT

Efficiently solving partially ordered top-quality planning includes receiving a first input associated with a planning problem. The planning problem is transformed into a single goal planning problem based on the reception of the first input. At least one stubborn set associated with the single goal planning problem is generated. Based on the at least one stubborn set, one or more extended stubborn sets associated with the single goal planning problem are determined. The one or more extended stubborn sets include at least one task action of a set of task actions associated with the single goal planning problem. A pruned search space associated with the single goal planning problem is determined based on the one or more extended stubborn sets. Based on the pruned search space, a set of solutions associated with the planning problem are determined and further rendered.

### BACKGROUND

The disclosure relates to automated planning and more particularly to efficiently solving partially ordered top-quality planning.

With the advancements of artificial intelligence technologies, automated planning is widely utilized to generate a sequence of actions that transitions various systems from an initial state to a desired goal state. The sequence of actions may be referred to as a “plan”. Various systems (such as intelligent agent systems, automated robotic systems, and unmanned vehicle systems) execute such a generated sequence of actions for performing one or more operations associated with decision-making and action sequencing. The one or more operations include robotic operations, logistics operations, manufacturing operations, and the like. However, there are challenges associated with the determination of solutions for automated planning. For example, a search space for the determination of the solutions for automatic planning may increase exponentially corresponding to an increase in the number of states and a number of actions. Further, the exponential increase in the search space may lead to an increase in computational complexity associated with the determination of the solutions for the automated planning. Moreover, the increased computational complexity can further increase challenges in the determination of the solutions for automated planning in a feasible amount of time.

### SUMMARY

According to an embodiment of the disclosure, a computer-implemented method for efficiently solving partially ordered top-quality planning is described. The computer-implemented method comprises receiving, by a computer, a first input associated with a planning problem. The computer-implemented method further comprises transforming, by the computer, the planning problem into a single goal planning problem based on the reception of the first input. The computer-implemented method further comprises generating, by the computer, at least one stubborn set associated with the single goal planning problem. The computer-implemented method further comprises determining, by the computer, one or more extended stubborn sets associated with the single goal planning problem based on the at least one stubborn set. The one or more extended stubborn sets comprises of at least one task action of a set of task actions associated with the single goal planning problem. The computer-implemented method further comprises determining, by the computer, a pruned search space associated with the single goal planning problem based on the one or more extended stubborn sets. The computer-implemented method further comprises determining, by the computer, a set of solutions associated with the planning problem based on the pruned search space. The computer-implemented method further comprises rendering, by the computer, the set of solutions associated with the planning problem.

According to an embodiment of the disclosure, a system for efficiently solving partially ordered top-quality planning is described. The system comprises a processor set configured to receive a first input associated with a planning problem. The processor set is further configured to transform the planning problem into a single goal planning problem based on the reception of the first input. The processor set is further configured to determine one or more adapted stubborn sets associated with the single goal planning problem. The processor set is further configured to determine a pruned search space associated with the single goal planning problem based on the one or more adapted stubborn sets. The processor set is further configured to determine a set of solutions associated with the planning problem based on the pruned search space. The processor set is further configured to render the set of solutions associated with the planning problem.

According to one or more embodiments of the disclosure, a computer program product for efficiently solving partially ordered top-quality planning is described. The computer program product includes a computer-readable storage medium having program instructions embodied therewith, the program instructions executable by a system to cause the system to receive a first input associated with a planning problem. The program instructions executable by the system to cause the system to transform the planning problem into a single goal planning problem based on the reception of the first input. The program instructions executable by the system to cause the system to generate at least one stubborn set associated with the single goal planning problem. The program instructions executable by the system to cause the system to determine one or more extended stubborn sets associated with the single goal planning problem based on the at least one stubborn set. The one or more extended stubborn sets comprises of at least one task action of a set of task actions associated with the single goal planning problem. The program instructions executable by the system to cause the system to determine a pruned search space associated with the single goal planning problem based on the one or more extended stubborn sets. The program instructions executable by the system to cause the system to determine a set of solutions associated with the planning problem based on the pruned search space. The program instructions are executable by the system to cause the system to render the set of solutions associated with the planning problem.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for efficiently solving partially ordered top-quality planning, in accordance with an embodiment of the disclosure;

FIG. 2 is a diagram that illustrates an environment for efficiently solving partially ordered top-quality planning, in accordance with an embodiment of the disclosure;

FIG. 3 is a diagram that illustrates an exemplary first set of operations for efficiently solving partially ordered top-quality planning, in accordance with an embodiment of the disclosure;

FIG. 4 is a diagram that illustrates an exemplary second set of operations for efficiently solving partially ordered top-quality planning, in accordance with an embodiment of the disclosure;

FIG. 5A, FIG. 5B, and FIG. 5C depict experimental evaluation results for the disclosed first method and second method for efficiently solving partially ordered top-quality planning, in accordance with an embodiment of the disclosure;

FIG. 6 is a flowchart that illustrates an exemplary first method for efficiently solving partially ordered top-quality planning, in accordance with an embodiment of the disclosure;

FIG. 7 is a flowchart that illustrates an exemplary second method for efficiently solving partially ordered top-quality planning, in accordance with an embodiment of the disclosure.

### DETAILED DESCRIPTION

With the advancements in artificial intelligence technologies, automated planning is widely utilized to generate a sequence of actions that transitions various systems (or agents) from an initial state to a desired goal state. Traditional methods may employ top-quality planning methods for the generation of the sequence of actions. The top-quality planning methods may generate the sequence of actions based on a set of possible initial states, a set of desired goals, and a set of possible actions. Further, an application of at least one action of the sequence of actions on at least one of the set of possible states may lead to a generation of a state that includes at least one of a set of desired goals (such a state may be referred to as “goal state”). However, there are challenges associated with the determination of the sequence of actions using the top-quality planning methods. For example, the top-quality planning methods may include a first limitation associated with the utilization of each action of the set of possible actions for the generation of the sequence of actions. Based on the first limitation, a computational complexity associated with the generation of the sequence of actions may increase exponentially corresponding to an increase in the number of possible states in the set of possible states and the number of possible actions in the set of possible actions. Moreover, the increased computational complexity can further increase challenges in the generation of the sequence of actions in a feasible (or desirable) amount of time.

Traditional methods may further employ unordered top-quality planning for the generation of the sequence of actions. The unordered top-quality planning may generate the sequence of actions based on a second limitation. The second limitation may be associated with an equivalence of an order of the set of possible actions. In an example, based on a determination that a first plan and a second plan of the set of possible actions include the same actions from the set of possible actions, the first plan and the second plan are determined as equivalent. However, the second limitation may prevent the execution of the set of possible actions in an optimal order, leading to an inability to reach the goal state.

Hence, to efficiently generate the sequence of actions for performing the one or more operations, there is a need for a system that can overcome the described first limitation and the second limitation. In an embodiment of the disclosure, the system may correlate the first limitation and the second limitation by using the partially ordered top-quality planning. The correlation allows for the determination of a set of solutions associated with a partially ordered top-quality planning problem in a pruned search space.

According to an embodiment of the disclosure, a computer-implemented method for efficiently solving partially ordered top-quality planning is described. The computer-implemented method comprises receiving, by a computer, a first input associated with a planning problem. The computer-implemented method further comprises transforming, by the computer, the planning problem into a single goal planning problem based on the reception of the first input. The computer-implemented method further comprises generating, by the computer, at least one stubborn set associated with the single goal planning problem. The computer-implemented method further comprises determining, by the computer, one or more extended stubborn sets associated with the single goal planning problem based on the at least one stubborn set. The one or more extended stubborn sets comprises of at least one task action of a set of task actions associated with the single goal planning problem. The computer-implemented method further comprises determining, by the computer, a pruned search space associated with the single goal planning problem based on the one or more extended stubborn sets. The computer-implemented method further comprises determining, by the computer, a set of solutions associated with the planning problem based on the pruned search space. The computer-implemented method further comprises rendering, by the computer, the set of solutions associated with the planning problem.

In an embodiment of the disclosure, the first input comprises a set of finite-domain state variables, a set of actions, an initial state, a goal state, a cost associated with each action of the set of actions, a cost threshold, and the set of task actions.

In an embodiment of the disclosure, the set of solutions corresponds to a set of plans, and a cost associated with each plan of the set of plans is less than the cost threshold.

In an embodiment of the disclosure, the computer-implemented method further comprises executing, by the computer, a planner algorithm based on the pruned search space. The computer-implemented method further comprises determining, by the computer, the set of solutions associated with the planning problem based on the execution of the planner algorithm.

In an embodiment of the disclosure, the set of solutions corresponds to a set of plans to be executed for solving the planning problem.

In an embodiment of the disclosure, the planner algorithm corresponds to a K* planner algorithm.

In an embodiment of the disclosure, the computer-implemented method further comprises identifying, by the computer, one or more duplicate plans in the set of plans. The computer-implemented method further comprises removing, by the computer, the one or more duplicate plans from the set of plans to update the set of plans. The computer-implemented method further comprises rendering, by the computer, the updated set of solutions associated with the planning problem.

In an embodiment of the disclosure, the computer-implemented further comprises determining, by the computer, a time period associated with the determination of the set of solutions associated with the planning problem. The computer-implemented further comprises rendering, by the computer, the time period. The time period is indicative of a time taken for the determination of the set of solutions associated with the planning problem.

According to another embodiment of the disclosure, there is provided a system for efficiently solving partially ordered top-quality planning. The system comprises a processor set configured to receive a first input associated with a planning problem. The processor set is further configured to transform the planning problem into a single goal planning problem based on the reception of the first input. The processor set is further configured to determine one or more adapted stubborn sets associated with the single goal planning problem. The processor set is further configured to determine a pruned search space associated with the single goal planning problem based on the one or more adapted stubborn sets. The processor set is further configured to determine a set of solutions associated with the planning problem based on the pruned search space. The processor set is further configured to render the set of solutions associated with the planning problem.

In an embodiment of the disclosure, the first input comprises a set of finite-domain state variables, a set of actions, an initial state, a goal state, a cost associated with each action of the set of actions, a cost threshold, and a set of task actions.

In an embodiment of the disclosure, the set of solutions corresponds to a set of plans, and a cost associated with each plan of the set of plans is less than the cost threshold.

In an embodiment of the disclosure, the processor set is further configured to execute a planner algorithm based on the pruned search space. The processor set is further configured to determine the set of solutions associated with the planning problem based on the execution of the planner algorithm.

In an embodiment of the disclosure, the planner algorithm corresponds to a K* planner algorithm.

In an embodiment of the disclosure, the set of solutions corresponds to a set of plans to be executed for a solution to the planning problem.

In an embodiment of the disclosure, the processor set is further configured to identify one or more duplicate plans in the set of plans. The processor set is further configured to remove the one or more duplicate plans from the set of plans to update the set of plans. The processor set is further configured to render the updated set of solutions associated with the planning problem.

In an embodiment of the disclosure, the processor set is further configured to determine a time period associated with the determination of the set of solutions associated with the planning problem. The processor set is further configured to render the time period. The time period is indicative of a time taken for the determination of the set of solutions associated with the planning problem.

According to yet another embodiment of the disclosure, there is provided a computer program product for efficiently solving partially ordered top-quality planning. The computer program product comprises a computer-readable storage medium having program instructions embodied therewith, the program instructions executable by a system to cause the system to receive a first input associated with a planning problem. The program instructions executable by the system to cause the system to transform the planning problem into a single goal planning problem based on the reception of the first input. The program instructions executable by the system to cause the system to generate at least one stubborn set associated with the single goal planning problem. The program instructions executable by the system to cause the system to determine one or more extended stubborn sets associated with the single goal planning problem based on the at least one stubborn set. The one or more extended stubborn sets comprises of at least one task action of a set of task actions associated with the single goal planning problem. The program instructions executable by the system to cause the system to determine a pruned search space associated with the single goal planning problem based on the one or more extended stubborn sets. The program instructions executable by the system to cause the system to determine a set of solutions associated with the planning problem based on the pruned search space. The program instructions are executable by the system to cause the system to render the set of solutions associated with the planning problem.

In an embodiment of the disclosure, the first input comprises a set of finite-domain state variables, a set of actions, an initial state, a goal state, a cost associated with each action of the set of actions, a cost threshold, and the set of task actions.

In an embodiment of the disclosure, the set of solutions corresponds to a set of plans, and a cost associated with each plan of the set of plans is less than the cost threshold.

In an embodiment of the disclosures, the program instructions executable by the system to cause the system to execute a planner algorithm based on the pruned search space. The program instructions executable by the system to cause the system to determine the set of solutions associated with the planning problem based on the execution of the planner algorithm.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

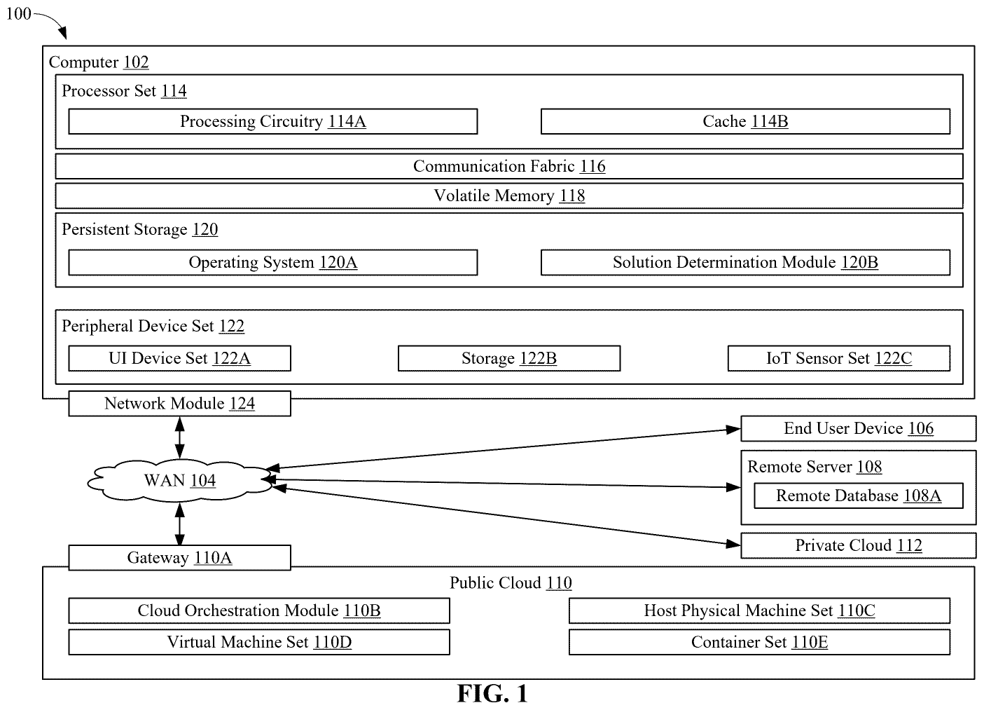

FIG. 1 is a diagram that illustrates a computing environment for efficiently solving partially ordered top-quality planning, in accordance with an embodiment of the disclosure. With reference to FIG. 1, there is shown a computing environment 100 that contains an exemplary environment for execution of at least one module involved in performing the methods, such as a solution determination module 120B associated with the determination of the solutions for the partially ordered top-quality planning. In addition to the solution determination module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the solution determination module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the other storage media discussed below. The program instructions, and associated data, are accessed by the processor set 114 to control and direct the performance of the methods. In computing environment 100, at least some of the instructions for performing the methods may be stored in the solution determination module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The solution determination module 120B typically includes the at least one module involved in performing the methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In some embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In other embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economics of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in other embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

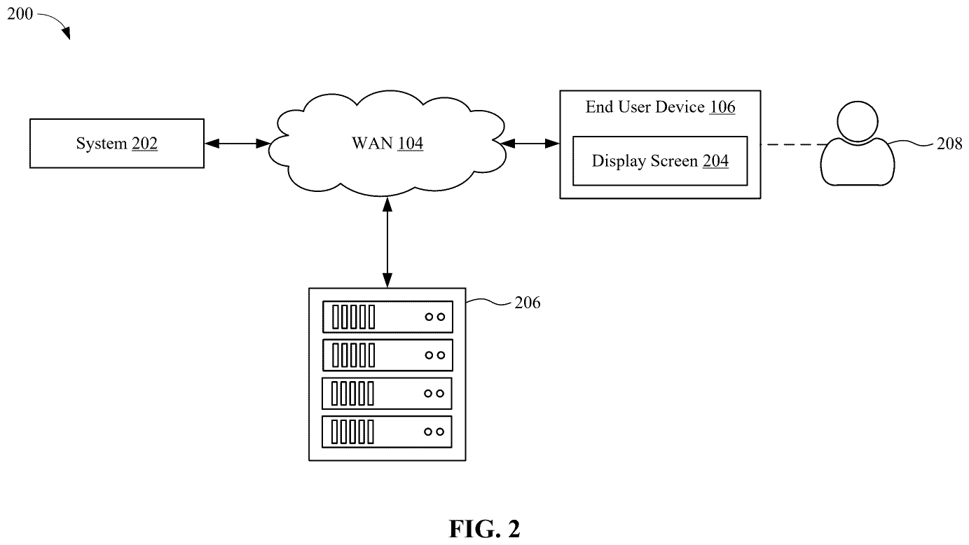

FIG. 2 is a diagram that illustrates an environment for efficiently solving partially ordered top-quality planning, in accordance with an embodiment of the disclosure. FIG. 2 is explained in conjunction with elements from FIG. 1. With reference to FIG. 2, there is shown a diagram of a network environment 200. The network environment 200 includes a system 202, a display screen 204, a server 206, and a user 208. The network environment 200 may further include the EUD 106, and the WAN 104 of FIG. 1. In an embodiment, the system 202 may be an exemplary embodiment of the computer 102 of FIG. 1.

The system 202 may include suitable logic, circuitry, interfaces, and/or code that are configured for efficiently solving partially ordered top-quality planning. The system 202 is configured to receive a first input associated with a planning problem. The system 202 is further configured to transform the planning problem into a single goal planning problem based on the reception of the first input. The system 202 is further configured to generate at least one stubborn set associated with the single goal planning problem. The system 202 is further configured to determine one or more extended stubborn sets associated with the single goal planning problem based on the at least one stubborn set. The one or more extended stubborn sets include at least one task action of a set of task actions associated with the single goal planning problem. The system 202 is further configured to determine a pruned search space associated with the single goal planning problem based on the one or more extended stubborn sets. The system 202 is further configured to determine a set of solutions associated with the planning problem based on the pruned search space. The system 202 is further configured to render the set of solutions associated with the planning problem. Examples of the system 202 may include, but are not limited to, a server, a computing device, a virtual computing device, a robot, a mainframe machine, a computer workstation, a smartphone, a cellular phone, a mobile phone, a gaming device, or a consumer electronic (CE) device.

The EUD 106 may include suitable logic, circuitry, interfaces, and/or code that are configured to provide the first input associated with the planning problem to the system 202. In an embodiment, system 202 is configured to control the display screen 204 of the EUD 106 to render the set of solutions associated with the planning problem. Examples of the EUD 106 may include, but are not limited to, a computing device, a mainframe machine, a server, a computer workstation, a smartphone, a cellular phone, a mobile phone, a gaming device, a consumer electronic (CE) device and/or any other device with backup and the processing capabilities.

The display screen 204 may comprise suitable logic, circuitry, and interfaces that are configured to render the determined set of solutions associated with the planning problem. In an embodiment, the display screen 204 is configured to render at least one of the single goal planning problems, the at least stubborn set, the one or more extended stubborn sets, and the pruned search space. In an embodiment, the display screen 204 may further display one or more user interface elements from which the user 208 may be able to provide the first input to the system 202. In an embodiment, the display screen 204 may be an external display device associated with the EUD 106. The display screen 204 may be a touch screen which may enable the user 208 to provide the first input via the display screen 204. The touch screen may be at least one of a resistive touch screen, a capacitive touch screen, or a thermal touch screen. The display screen 204 may be realized through several known technologies such as, but are not limited to, at least one of a Liquid Crystal Display (LCD) display, a Light Emitting Diode (LED) display, a plasma display, or an Organic LED (OLED) display technology, or other display devices. In an embodiment, the display screen 204 may refer to a display screen of a head-mounted device (HMD), a smart-glass device, a see-through display, a projection-based display, an electro-chromic display, or a transparent display.

In an embodiment, the EUD 106 may be associated with the user 208 who may wish to solve the planning problem to determine the set of solutions to be executed to reach a desired goal state from the initial state. By way of example and not limitation, the user 208 may correspond to a robotic engineer who may wish to determine the set of operations for warehouse automation, automobile navigations, and the like. By way of another example and not limitation, the user 208 corresponds to a logistics coordinator who may wish to determine the set of operations for route planning, assembly line scheduling, and the like.

The server 206 may include suitable logic, circuitry, and interfaces, and/or code that are configured to store the determined set of solutions associated with the planning problem. In an embodiment of the disclosure, the system 202 is configured to obtain the set of solutions from the server 206. In an embodiment of the disclosure, the server 206 is configured to store the single goal planning problem, the at least stubborn set, the one or more extended stubborn sets, one or more adapted stubborn sets, and the pruned search space. In an embodiment of the disclosure, the server 212 is implemented as a cloud server and may execute operations through web applications, cloud applications, HTTP requests, repository operations, file transfer, and the like. Other example implementations of the server 212 include, but are not limited to, a database server, a file server, a web server, a media server, an application server, a mainframe server, or a cloud computing server.

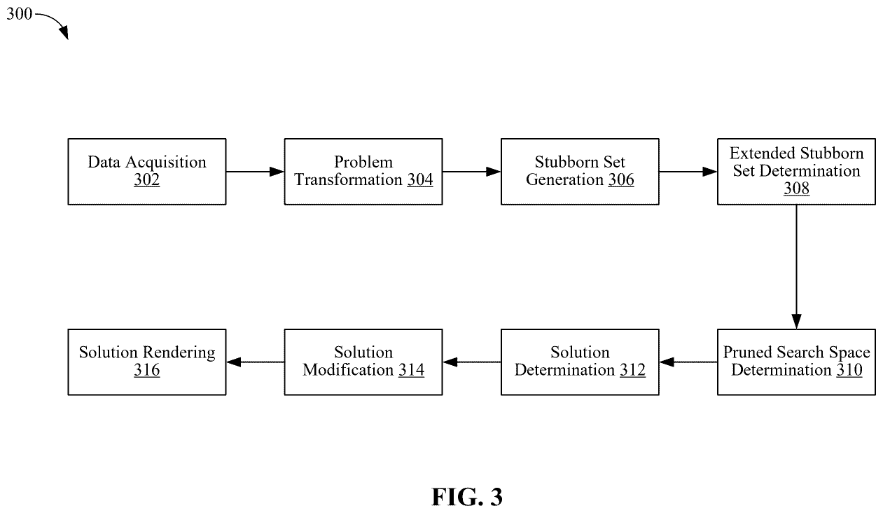

In operation, the system 202 is configured to receive the first input associated with the planning problem. The first input may include a set of finite-domain state variables, a set of actions, an initial state, a goal state, a cost associated with each action of the set of actions, a cost threshold, and a set of task actions. In an embodiment, the set of finite-domain state variables, the set of actions, the initial state, the goal state, the cost associated with each action of the set of actions, the cost threshold, and the set of task actions may be associated with the planning problem. Details about the set of finite-domain state variables, the set of actions, the initial state, the goal state, the cost associated with each action of the set of actions, the cost threshold, and the set of task actions are provided, for example, in FIG. 3.

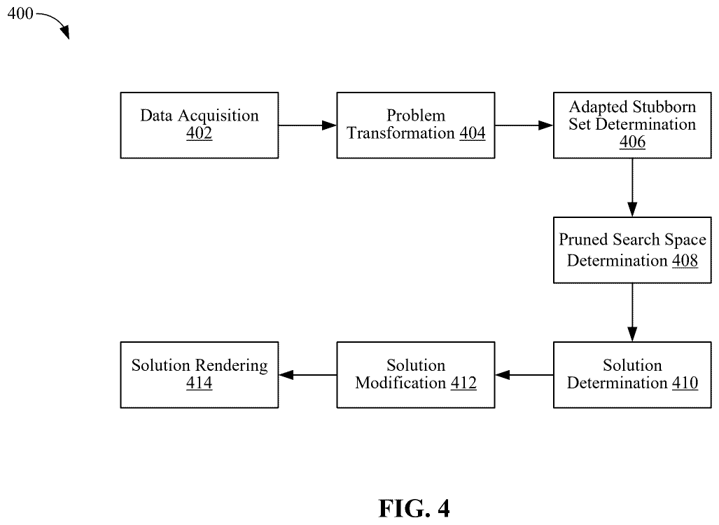

The system 202 is configured to transform the planning problem into the single goal planning problem based on the reception of the first input. The single goal planning problem may involve finding a sequence of actions that transforms the initial state into a single specific goal state within a defined state space. Similar to the planning problem, the single goal planning problem may be characterized by the finite set of state variables with finite domains, the single initial state, the set of available actions, and one specific goal state that the planning process aims to achieve. The objective of the single goal planning problem may be to identify a plan, which is an ordered sequence of actions, that leads from the initial state to the goal state, ensuring that each action's preconditions are met in the current state and applying the action transitions the system closer to the goal. Details about the single goal planning problem are provided, for example, in FIG. 3 and FIG. 4.

The system 202 is configured to generate the at least one stubborn set associated with the single goal planning problem. In an embodiment of the disclosure, the at least one stubborn set corresponds to a subset of the set of actions. Based on the at least one stubborn set, the system 202 is configured to identify at least one action of the set of actions that may be pruned for the determination of the set of solutions associated with the planning problem. In an embodiment of the disclosure, the system 202 is configured to determine the at least one stubborn set based on an application of a set of predefined criteria on the subset of the set of actions. Details about the at least one stubborn set are provided for example, in FIG. 3.

The system 202 is further configured to determine one or more extended stubborn sets associated with the single goal planning problem based on the at least one stubborn set. The one or more extended stubborn sets may include at least one task action of the set of task actions associated with the single goal planning problem. The system 202 is configured to determine the pruned search space associated with the single goal planning problem based on the one or more extended stubborn sets. The system 202 is configured to determine the set of solutions associated with the planning problem based on the pruned search space. The system 202 is further configured to render the set of solutions associated with the planning problem. Details about the set of solutions are provided, for example, in FIG. 3.

FIG. 3 is a diagram that illustrates an exemplary first set of operations for efficiently solving partially ordered top-quality planning, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 316, as described herein. The exemplary operations illustrated in the block diagram 300 may start at 302 and may be performed by any computing system, apparatus, or device, such as by the system 202 of FIG. 2 or processor set 114 of FIG. 1. Although illustrated with discrete blocks, the exemplary operations associated with one or more blocks of the block diagram 300 may be divided into additional blocks, combined into fewer blocks, or eliminated, depending on the particular implementation.

At 302, a data acquisition operation may be executed. In the data acquisition operation, the system 202 may receive a first input associated with a planning problem (also referred to as a planning task). Generally, the planning problem may correspond to the challenge of determining a sequence of actions that will transition an agent (such as a robot) from an initial state to a desired goal state, within the constraints of a given environment. Mathematically, the planning problem may be described by the equation (1) as follows:

$$Π = 〈 V , O , {S}_{0} , {S}_{⋆} , cost 〉 \qquad ( 1 )$$

Where,
Π corresponds to the planning problem (or the planning task),
V corresponds to a finite set of finite-domain state variables,
O corresponds to a finite set of actions,
S₀ corresponds to an initial state,
S_{*} corresponds to a final state (or a goal state),
cost corresponds to a cost associated with each action.

The finite set of finite-domain state variables (V) may define the different attributes or aspects of the agent being modeled. Each variable (v) has a finite set of possible values it can take, representing different possible states of a world in which the agent may operate. Specifically, each variable v∈V may be associated with a finite domain D(v) of variable values. In an embodiment, a partial assignment p maps a subset of variables V(p)‥V to values in their domains. For a variable v∈V and partial assignment p, the value of v in p may be denoted by p[v] if v∈V(p), and it may be said that p[v] is undefined if v/E V(p). A partial assignment s with V(s)=V is called a state. Each state ‘s’ is consistent with partial assignment p if they agree on all variables in V(p), denoted by p⊆s. A state ‘s’ is called a goal state if s*⊆s and the set of all goal states is denoted by S_{s*}. The initial state (s₀) provides a complete description of all state variables at the beginning of the planning process. The initial state (s₀) may correspond to a state from which the planning process starts. The goal state (s*) may correspond to a desired end state or set of conditions to be achieved.

Each action (o) of the finite set of actions (O) may represent the possible operations or changes that can be made to the state of the world. Each action o∈O may be characterized by a pre-condition (pre(o)), and an effect (eff(o)). The precondition may correspond to conditions that must hold true in the current state for the action to be executable or a partial assignment of variables that must be true for the action to be applicable. The effect may be a partial assignment of variables that may specify how the state changes when the corresponding action is applied. In other words, the effect may describe how the state is modified after the corresponding action is executed. In an embodiment, each action ‘o’ may have an associated cost w*(o) ER⁰⁺. The cost, which may be optional, is a numerical value that represents an effort, time, or resources required to perform the action. An action ‘o’ may be applicable in state ‘s’ if pre(o)⊆s. Actions that may be applicable at state ‘s’ may be denoted by O(s). In an embodiment, the application of action ‘o’ in state ‘s’ may result in a state denoted by s [symbol] o [symbol] where s [symbol] o [symbol] [v]=eff(o)[v] for all v∈V (eff) and s [symbol] o [symbol] [v]=s[v] for all other variables.

The primary objective of a planning problem is to find a plan, which may be a sequence of actions, that transitions the system from the initial state (s₀) to the final state (s*). This may involve determining which actions may be applicable based on their preconditions, applying actions to transition between states according to their effects, ensuring the final state meets the goal conditions, and optionally optimizing the plan to minimize the total cost if action costs are defined.

By way of example and not limitation, a robot navigation problem may be formulated as the planning problem may be described as follows:
State Variables (V): {RobotPosition} with domain {RoomA, RoomB, RoomC}.
Actions (O): {Move (A, B), Move (B, C), Move (C, A)}, each with specific preconditions and effects on RobotPosition.
Initial State (so): {RobotPosition RoomA}.
Goal Condition (G): {RobotPosition RoomC}.

The planning problem may be to find the sequence of actions (i.e. moves) that will take the robot from RoomA to RoomC. The solution will be the sequence of actions that transforms the initial state into a state that meets the goal condition (or the goal state).

It may be noted that an action sequence π=<o₁, o_{2, . . .} oₙ> may be applicable in state ‘s’ if there are states s₁, . . . , sₙ₊₁ such that s=s₁, oᵢ is applicable in sᵢ and sᵢ [symbol] oᵢ [symbol] =sᵢ₊₁ for 0≤i≤n. The final state after applying the action sequence π may be denoted by s [symbol] π [symbol] . An action sequence that transforms the initial state (s₀) into the goal state s [symbol] π [symbol] ∈S_{s*} is called a plan. The cost of the plan, which may be denoted by w*(T) may be the sum of the costs of the actions in the plan. The set of all possible plans is denoted by P_{π}. A plan may be considered optimal if its cost is the minimum among all plans in P_{π}. In this context, “optimal plan” may refer to a plan whose total cost is the lowest possible among all feasible plans in the set of all possible plans P_{π}. Specifically, the optimal plan achieves the desired goal while incurring the minimal cumulative cost of actions, compared to all other plans that could also achieve the goal. Therefore, a plan π∈P_{π} is optimal if w*(π)≤w*(π′) for all π′∈P_{π}, wherein w*(π) represents the cost of plan π.

In an embodiment, the first input may include the set of finite-domain state variables (V), the set of actions (O), the initial state (s₀), the goal state (s*), and the cost associated with each action (o) of the set of actions (O). Furthermore, the first input may include a cost threshold (q), and a set of task actions (T). The cost threshold (q) may correspond to a specified upper limit on the total cost of the actions in the plan. Specifically, while solving the planning problem, the goal is to find the sequence of actions that not only transitions the agent from the initial state to the goal state but also ensures that the cumulative cost of the sequence of actions is not greater than the predefined cost threshold (q).

The set of task actions (X) may correspond to a specific subset of the set of actions that may be particularly relevant for solving the planning problem. The set of task actions may be often identified based on their relevance or role in achieving the goal state. In an embodiment, the set of task actions may be selected for their relevance to the task at hand.

The set of task actions (X) may be a specific subset of the broader set of actions (O). While the set of actions (O) represents the complete set of all possible actions available in the planning problem, the set of task actions (X) focuses on the actions directly related to achieving a particular task or goal. The set of actions (O) includes every possible state transition the agent may perform, encompassing actions that may not be immediately relevant to the current task. In contrast, the set of task actions (X) contains only those actions that may be required for reaching the goal state from the initial state, making the planning process more efficient by concentrating on pertinent actions.

For example, consider a robot tasked with navigating a warehouse to pick up and deliver a package. The set of actions \(O\) might include moving in different directions (up, down, left, right), picking up the package, delivering the package, recharging the battery, performing diagnostics, and sending status updates. However, the set of task actions (X) may focus on the actions directly related to the delivery task: moving in different directions, picking up the package, and delivering it. Therefore, the set of actions (O)={Move up, Move down, Move left, Move right, Pick up the package, Deliver package, Recharge battery, Perform diagnostics, Send status update}), while the set of task actions X={Move up, Move down, Move left, Move right, Pick up the package, Deliver package}.

At 304, a problem transformation operation may be executed. In the problem transformation operation, the system 202 may transform the planning problem into the single goal planning problem. In an embodiment, the planning problem may be transformed into the single goal planning problem based on the reception of the first input. Specifically, the single goal planning problem may correspond to a simplified version of a planning problem where the objective may be to achieve a single specific goal state from the initial state. In comparison with the planning problem, the planning problem may be a more general version of the planning problem where the objective is to achieve one or more goal states from a given initial state. In an embodiment, the planning problem may be transformed into a set of single goal planning problems.

Specifically, the single goal planning problem may involve finding the sequence of actions that transforms the initial state into a specific goal state within a defined state space. This problem is characterized by the finite set of state variables with finite domains, the single initial state, the finite set of actions, and only one specific goal state that the planning process aims to achieve. The objective of the single goal planning problem is to identify a plan, which is an ordered sequence of actions, that leads from the initial state to the goal state, ensuring that each action's preconditions are met in the current state and applying the action transitions the system closer to the goal state.

The planning problem involves finding the sequence of actions to transition from the initial state to any state that satisfies the set of goal conditions, which may include multiple objectives or partial assignments over several state variables. In contrast, the single goal planning problem may focus on reaching one specific goal state, where the desired values for all relevant state variables may be fully defined. While the planning problem is broader and can address multiple possible goal states and conditions, the single goal planning problem may be narrower, targeting a single, well-defined endpoint.

In an embodiment, the transformation of the planning problem into a single goal planning problem may involve breaking down the complex planning task, which may have multiple sub-goals or objectives, into simpler tasks, each with a specific, well-defined goal. This process helps streamline the planning and solution-finding process by focusing on one goal at a time, making it easier to manage and solve. To achieve this, the system 202 may initially identify sub-goals within the main goal, formulate separate single goal planning problems for each sub-goal, solve each of these simpler problems independently, and then integrate the solutions to form a comprehensive plan for the original, more complex planning problem.

From one planning problem, multiple single goal planning problems can be generated by specifying different single goal states that meet the broader goal conditions. For instance, a robot is tasked with navigating a warehouse to pick up and deliver multiple packages to different locations. This complex planning problem may be transformed into several single goal planning problems. Firstly, the system 202 may identify sub-goals such as navigating to the location of Package 1, picking up Package 1, delivering Package I to its designated spot, and repeating similar steps for Package 2. Each sub-goal may represent a significant step towards achieving the overall objective.

The system 202 may further formulate single goal planning problems for each sub-goal. For instance, one planning problem might involve navigating from the starting position to the location of Package 1, with actions such as moving up, down, left, or right. Another planning problem might involve picking up Package 1, with the action of picking up the package. This process may be repeated for each sub-goal, thereby creating a series of simpler planning problems.

The system 202 may further solve each of these single goal planning problems independently. For example, the system 202 may find a path from the starting position to the location of Package 1, plan the action to pick up Package 1, and further find another path from the location of Package 1 to its delivery point. By addressing each sub-goal individually, the overall planning process may be simplified. Details about solving each of the single goal planning problem are provided below.

Finally, the system 202 may integrate the solutions of the single goal planning problems to form the overall plan. This may involve combining the solutions to create a comprehensive sequence of actions that the robot may follow to achieve the main goal. For instance, the integrated solution might involve navigating to Package 1, picking up Package 1, delivering Package 1, navigating to Package 2, picking up Package 2, and delivering Package 2.

It may be noted that transforming a planning problem into a single goal planning problem may simplify the planning process, thereby making it more manageable and efficient. Furthermore, by breaking down a complex problem into simpler sub-tasks with specific goals, each single goal planning problem may be solved independently, allowing for modular and scalable solutions. This approach makes it easier to address the original complex problem by focusing on one goal at a time and integrating the solutions into a comprehensive plan.

At 306, a stubborn set generation operation may be executed. In the stubborn set generation operation, the system 202 may generate at least one stubborn set associated with the single goal planning problem. In an embodiment, stubborn sets are a technique used in automated planning to reduce the number of states that need to be explored by identifying and pruning actions that do not need to be considered at every step of the search process. Specifically, the stubborn set may be a subset of actions that may be sufficient to consider from a given state to ensure that all possible goal states (or the single goal state) may still be reached, even if other actions are ignored temporarily.

As discussed above, the stubborn set may be the subset of actions that may be sufficient to consider from the given state while preserving the completeness and optimality of the search. Given the planning task π=<V, O, S₀, S_{*}, cost>, a stubborn set T⊆O for a state ‘s’ satisfies the properties of enabled action, dependence preservation, and goal achievement. The enabled action property ensures that if an action ‘a’ in ‘O’ is applicable in state ‘s’, then at least one action in ‘T’ is applicable in the state ‘s’. The dependence preservation may ensure that for every action ‘a’ not in ‘T’ that may be applicable in the state ‘s’, there may be an action ‘b’ in ‘T’ such that ‘a’ and ‘b’ are dependent. This may ensure that any interaction between action ‘a’ and actions in ‘T’ may be captured. The goal achievement property may ensure that if a sequence of actions leading to the goal exists, then there exists a sequence that uses actions from the stubborn set appropriately.

In an embodiment, the generation of the stubborn may include multiple steps such as, but not limited to, an independent actions determination step, an initial action selection step, and an expansion step. In the independent actions determination step, the system 202 may determine which actions are independent of each other based on their preconditions and effects. In the initial action selection step, the system 202 may select an action that may be applicable in the current state. In the expansion step, the system 202 may add one or more actions to the stubborn set to ensure that all dependencies are respected. For each action that may not be in the stubborn set that may affect the applicability or outcome of actions in the stubborn set, include actions that handle those dependencies.

By way of example and not limitation, the planning problem with the set of actions A={a,b,c,d} with action ‘a’ changes ‘x’ to 1, action ‘b’ changes ‘y’ to 1, ‘c’ changes ‘x’ to 2, ‘d’ changes ‘y’ to 2 respectively. In such a case, actions ‘a’ and ‘b’ are independent because they affect different variables ‘x’ and ‘y’. Similarly, actions ‘c’ and ‘d’ are independent. For the generation of the stubborn set, it may be assumed that from the initial state (s₀), the action ‘a’ may be applicable. Now if action ‘a’ is added to the stubborn set, the system 202 may check for the following dependencies:
‘b’ is independent of ‘a’.
‘c’ depends on the value of ‘x’ set by ‘a’, so ‘c’ should be considered in the stubborn set.
‘d’ is independent of ‘a’.
   Thus, the stubborn set ‘T’ may include {a,c} ensuring that all dependencies and interactions are preserved.

Therefore, the stubborn set may reduce the number of states and transitions that need to be explored in the planning problem by focusing on the subset of actions that may sufficiently represent the behavior of the environment or domain. By leveraging the independence and commutativity of actions, the stubborn set may enable a more efficient search while maintaining the guarantee of finding the optimal solution for the planning problem.

In an embodiment, the system 202 may determine the at least one stubborn set using the partial order reduction (POR) technique. Specifically, the partial order reduction (POR) may be a technique used in planning and model checking to reduce the number of states and transitions explored during the search process. The POR technique may focus on pruning redundant transitions without losing the completeness or optimality of the search. An example of the POR technique may be safe successor pruning of the states based on a safe successor pruning function.

The successor pruning function in planning tasks may be used to determine which successors (next possible states) of a given state should be explored. The goal may be to prune or ignore certain actions to reduce the number of state transitions, thereby making the search process more efficient. In other words, the successor pruning function may be defined as follows: Let “succ” be a successor pruning function for a planning task II. The successor pruning function “succ” may be said to be safe if, for every state ‘s’, the cost of an optimal solution from ‘s’ is the same in both the pruned state space induced by “succ” and the full state space.

It may be noted that the stubborn set may be a method to achieve the safe successor pruning. The stubborn set may help in identifying actions that can be safely ignored at each node expansion during the search process. By defining the set of actions such that if an action is not in the set, it can be safely ignored, stubborn sets ensure the pruned state space still contains an optimal solution.

Further, it may be noted that interference and necessary enabling sets (NES) may be two key concepts in the context of stubborn sets, which may be used for safe successor pruning in planning tasks. Interference may refer to the relationship between actions where one action affects the preconditions or outcomes of another. Specifically, two actions interfere if the execution of one can disable or conflict with the execution of the other. For example, if action ‘a’ changes a variable that action ‘b’ depends on, then it may be said that actions ‘a’ and ‘b’ interfere. This interference must be considered when constructing stubborn sets to ensure that all relevant actions are included, preserving the feasibility of achieving the goal.

The Necessary Enabling Sets (NES) may pertain to actions that may be required to enable another action within the planning problem. The NES for an action ‘o’ may be a set of actions that must appear in the sequence leading up to ‘o’ before its first occurrence. This may indicate that for action ‘o’ to be executable, certain other actions must have been executed beforehand to satisfy the preconditions of the action ‘o’. By identifying these enabling actions, the NES may help in constructing the stubborn set that includes all relevant prerequisites, ensuring that relevant paths to the goal are not pruned away.

Together, interference and NES help determine which actions are crucial and should be included in the stubborn set, allowing for safe pruning of non-relevant actions without losing the ability to find an optimal solution.

In an embodiment, the stubborn sets may correspond to a generalized strong stubborn set (GSSS). The Generalized Strong Stubborn Sets (GSSS) may be a refinement of the concept of stubborn sets. The GSSS may be designed to ensure that safe successor pruning can be applied effectively. The GSSS ensures that all relevant actions are included in the set, preserving the optimality and completeness of the search.

Let II be a planning task and ‘s’ be a solvable non-goal state. Let ‘S̅’ be the states along strongly optimal plans for ‘s’. A set T⊆O is a GSSS for ‘s’ if:
1. T contains actions that are part of a strongly optimal plan for ‘s’
2. For every o∈T\O(s), T contains an NES for ‘o’.
3. For every o∈T∩O(s), T contains all actions o′∈O that interfere with o in any state s∈S̅.
   The successor function T(s) under T therefore returns the applicable in ‘s’ actions from T, T(s):=O(s)∩T.

For a sequence of actions x and a subset of task actions X, a subsequence obtained from π by removing actions not in X may be denoted by π|X. Based on this, a relation over the set of all plans PII may be defined by equation (2) as follows:

$${P}_{X} = \{ ( π , {π}^{′} ) \vert π , {π}^{′} ∈ {P}_{π} , M S ( π ) = MS ( {π}^{′} ) , π \vert x = {π}^{′} \vert x \qquad ( 2 )$$

It may be noted that the relation P_{X} may be an equivalence relation. The relation P_{X} may be reflexive, transitive, and symmetric. With that relation, the partially ordered top-quality planning is defined as follows:

Let π be some planning task over the actions O and P_{π} be the set of its plans. The partially ordered top quality planning problem is defined as follows.

Given a set of actions X and a number q∈R⁰⁺, find a set of plans P⊆P_{π} that may be a solution to the quotient top-quality planning problem under the equivalence relation P_{X}.

The notion of safe successor pruning as described above may capture safety for cost-optimal planning, where any plan of minimal cost is a valid solution. However, when discussing top-quality planning in general and partially ordered top quality planning in particular, the notion of safety changes. The notion of safety changes may be as defined as follows:

Let ‘succ’ be a successor pruning function for a planning task II and let X be a subset of actions of II. The successor pruning function ‘succ’ may be considered safe for partially ordered top-quality planning if for every state s and for every plan πs for s, there exist a path π′ₛ in the pruned state space induced by ‘succ’, such that (πₛ, π′ₛ)∈P_{X}.

At 308, an extended stubborn set determination operation may be executed. In the extended stubborn set determination operation, the system 202 may determine one or more extended stubborn sets that may be associated with the single goal planning problem. In an embodiment, the system 202 may determine the extended stubborn set based on a set of applicable actions (O(s)) and the successor function T(s) (also known as a partial order reduction successor function T(s)). Specifically, the system 202 may determine an extended successor function that may be defined as shown in equation(s) as follows:

$${T}_{X} ( S ) = \{ \begin{matrix}T ( s ) , & T ( s ) ⋂ X \\ T ( s ) UX , & T ( s ) ⋂ X = ∅ ∧ X \backslash O ( s ) = ∅ \\ O ( s ) , & otherwise\end{matrix} \qquad ( 2 )$$

Where,
T_{X}(S) corresponds to the extended successor function,
T(s) corresponds to the successor function T(s),
O(s) corresponds to the set for applicable actions, and
X corresponds to the set of task actions.

It may be noted that the successor function Tx(S) may be safe for partial ordered top-quality planning when T is a GSSS. It may be further noted that the extended stubborn set may include the successor set, a union of the successor set and applicable actions, or a set for applicable actions. The extended stubborn sets may be calculated for each state during the search process.

It may be noted that the pruning technique may be deemed safe for unordered top-quality planning with a K* planner algorithm, as it may prune some reordering of the found plans. Consequently, the pruning technique may not be directly applied to top-quality planning or partially ordered top-quality planning. In order to be able to use partial order reduction-based pruning for partially ordered top quality planning, it must be ensured that the successor function is safe for partially ordered top-quality planning. This may be done because can be done by either modifying the partial order reduction algorithm (as defined at 406 in FIG. 4) or externally, by inspecting the reduced set of successor actions (as described at 308 in FIG. 3).

At 310, a pruned search space determination operation may be executed. In the pruned search space determination operation, the system 202 may determine a pruned search space based on the determined stubborn sets and extended stubborn sets. The pruned search space may correspond to a reduced version of the original state space in the planning problem, that may be obtained by eliminating certain states and transitions that are deemed superfluous for finding an optimal solution or a set of solutions of the planning problem. Such a reduction may be achieved through techniques such as safe successor pruning, stubborn sets, and extended stubborn sets as explained above. The goal of pruning the search space may be to improve the efficiency of the search process by focusing computational resources on the most relevant parts of the state space.

In an embodiment, the stubborn sets may have a pivotal role in the determination (or construction) of the pruned search space. As discussed above, the stubborn sets may identify the subset of actions that may be relevant for achieving the goal state from any given state. Such stubborn sets may be constructed to ensure that at least one optimal plan remains feasible within the reduced action set, thereby preserving the optimality and completeness of the search.

With reference to the pruned search space, the safe successor pruning technique may be applied using the determined at least one stubborn set. For each state encountered during the search, the successor function may be restricted to actions within the corresponding stubborn set. Such a restriction may significantly reduce the number of successor states generated, as actions that do not contribute to optimal plans may be ignored. By focusing only on the required (or relevant) actions, the search algorithm may avoid exploring large portions of the state space that do not lead to an optimal solution. This may result in improved efficiency of the search process by reducing computational overhead and managing memory usage more effectively.

Therefore, the stubborn sets may ensure the safety of pruning by including all required actions and accounting for action interference, thereby maintaining the feasibility of reaching the goal state. By leveraging stubborn sets, the pruned search space retains only the critical paths that need to be explored, leading to a more focused and efficient search process that guarantees finding an optimal solution.

By way of example and not limitation, consider a robot navigation task where the robot must move from a start position to a goal position within a grid while picking up and delivering an object. The full state space includes all possible movements and actions the robot can take in the grid, such as moving between cells, picking up the object, and delivering it to the destination. To simplify the search, the system 202 may use stubborn sets and extended stubborn sets to identify a subset of actions required for achieving the goal. For instance, to successfully pick up and deliver the object, the robot needs to move to the object's location first and then to the delivery point. The stubborn set and extended stubborn sets for these actions may include the relevant moves to reach the object's location and the pick-up action itself.

By applying the safe successor pruning, the search space may be reduced by ignoring actions that are not in the identified stubborn set and extended stubborn set. For example, if the robot is adjacent to the object, only the pick-up action and the relevant moves are considered, while other movements that do not lead to the goal may be ignored. This may result in the pruned state space that includes only the required paths leading to the goal, such as the specific moves to the object's location and the pick-up action. This reduction focuses on the most relevant actions and states, making the search process more efficient and manageable.

At 312, a solution determination operation may be executed. In the solution determination operation, the system 202 may determine a set of solutions that may be associated with the planning problem. The set of solutions may be determined based on the pruned search space. In an embodiment, the system 202 may execute a planner algorithm on the pruned search space. Based on the execution of the planner algorithm on the pruned search space, the system 202 may generate the set of solutions for the planning problem. Each solution of the set of solutions may correspond to a set of plans that satisfies the cost constraints and successfully transitions from the initial state to the goal state. Specifically, each plan may include a sequence of actions to be followed to transition from the initial state to the goal state. In an embodiment, a cost associated with each plan of the set of plans may be less than the cost threshold that may be included in the first input.

In an embodiment, the planner algorithm may correspond to a K* planner algorithm. The K* planner algorithm may be an advanced heuristic search algorithm that may be designed to address complex planning problems that may have stringent cost constraints. The K* planner algorithm builds upon traditional heuristic search methods by incorporating a dynamic programming approach to systematically explore the pruned state space. The primary objective of the K* planner algorithm is to find all feasible plans (or the set of plans) that includes the set of task actions (X) and whose costs do not exceed the given cost threshold (q), thereby ensuring both thoroughness and efficiency in the search process.

Generally, the K* planner algorithm may operate by maintaining a set of partial plans, which may be iteratively extended while their costs may be carefully monitored. At each step, the K* planner algorithm may evaluate potential extensions of the current partial plans, thereby incorporating actions that could lead to a goal state. The K* planner algorithm may employ the pruning techniques (as explained above) to discard paths that exceed the predefined cost threshold, thereby focusing computational resources on the most promising and cost-effective paths. This selective pruning may be crucial for managing the complexity of large state spaces and ensures that the K* planner algorithm remains computationally feasible even for extensive planning tasks.

The K* planner algorithm may use dynamic programming principles to efficiently manage and update the cost of partial plans. By storing and reusing intermediate results, the K* planner algorithm may avoid redundant calculations and significantly speed up the search process. This dynamic programming approach may allow the K* planner algorithm to systematically build upon previously computed plans, ensuring that each extension is cost-optimal and contributes to finding the best possible solution within the cost limit. Details about the K* planning algorithm are already known in the art and have been omitted for the sake of brevity.

At 314, a solution modification operation may be executed. In the solution modification operation, the system 202 may identify one or more duplicate plans in the set of plans. A plan may be deemed as a duplicate plan if the actions of the corresponding plan are the same as the actions in another plan and differ only in the sequence. In other words, the duplicate plans may correspond to equivalent plans. Two plans may be considered equivalent if both plans differ only in the order of the actions used Based on the identification of the one or more duplicate plans, the system 202 may remove the one or more duplicate plans from the set of plans to update the set of plans. Specifically, if there are 2 duplicate plans, then the system 202 may keep only the plan from the 2 duplicate plans in the updated set of plans.

In an embodiment, the set of plans may include a first plan that may be an optimal plan for the first single planning problem. The set of plans may further include a second plan that may be the optimal plan for the second single planning problem that may be formed from the planning problem. Similarly, the set of plans may further include an Nth plan that may be the optimal plan for an Nth single planning problem that may be formed from the planning problem. Specifically, the system 202 may integrate the set of solutions of the single goal planning problems to form an overall plan.

At 316, a solution rendering operation may be executed. In the solution rendering operation, the system 202 may render the updated set of plans associated with the planning problem. In an embodiment, the system 202 may render the updated set of plans associated with the planning problem on the display screen 204 associated with the EUD 106. In another embodiment, the rendering of the set of solutions may correspond to the transmission of the set of solutions to the agent for execution of the sequence of actions in the corresponding plan. In an embodiment, the system 202 may render the overall plan associated with the planning problem on the display screen 204 associated with the EUD 106.

In an embodiment, the system 202 may determine a time period associated with the determination of the set of solutions associated with the planning problem. The time period is indicative of a time taken for the determination of the set of solutions associated with the planning problem. Specifically, if the first input is received at time “t1” and the set of solutions may be determined at time “t2”, then the time period may indicate a time between the time “t2” and time “t1”. The system 202 may further render the determined time period along with the set of solutions on the display screen 204 associated with the EUD 106.

FIG. 4 is a diagram that illustrates an exemplary second set of operations for efficiently solving partially ordered top-quality planning, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 414, as described herein. The exemplary operations illustrated in the block diagram 400 may start at 402 and may be performed by any computing system, apparatus, or device, such as by the system 202 of FIG. 2 or processor set 114 of FIG. 1. Although illustrated with discrete blocks, the exemplary operations associated with one or more blocks of the block diagram 400 may be divided into additional blocks, combined into fewer blocks, or eliminated, depending on the particular implementation.

At 402, a data acquisition operation may be executed. In the data acquisition operation, the system 402 may receive a first input associated with a planning problem. Generally, the planning problem may involve determining a set of plans that includes a sequence of actions to achieve a specific goal from a given initial state within a defined environment. It requires identifying the optimal or feasible actions that transform the initial state into the desired goal state while adhering to any constraints or rules of the environment. For instance, in a robotics domain, a planning problem may entail programming a robot to navigate a warehouse, picking and delivering items efficiently, without colliding with obstacles or violating operational constraints. Details about the planning problem are provided, for example, at 302 in FIG. 3.

At 404, a problem transformation operation may be executed. In the problem transformation operation, the system 402 may transform the planning problem into a single goal planning problem. The single goal planning problem may be transformed based on the reception of the first input and may be associated with the planning problem. Specifically, the single goal planning problem may correspond to a simplified version of a planning problem where the objective is to achieve a single specific goal state from the initial state. In comparison with the planning problem, the planning problem may be a more general version of the planning problem where the objective is to achieve one or more goal states from the given initial state. In an embodiment, the planning problem may be transformed into a set of single goal planning problems. Details about the single goal planning problem are provided, for example, at 304 in FIG. 3.

At 406, an adapted stubborn set determination operation may be executed. In the adapted stubborn set determination operation, the system 202 may determine one or more adapted stubborn sets. The system 202 may determine the one or more adapted stubborn sets based on the single goal planning problem. To determine the one or more adapted stubborn sets, the system 202 may modify the definition of generalized strong stubborn sets (GSSS) as described at 310 in FIG. 3. Specifically, the system 202 may extend condition (iii) of the GSSS by adding another condition on top of interference. Therefore, it may be said that two actions o and o′ are X-unorderable if both o∈X and o′∈X.

Specifically, the system 202 may modify the definition of the GSSS as follows: Let π be a planning task over the actions O and X⊂O be some set of its actions. Let ‘s’ be a solvable non-goal state. Let S be the states along strongly optimal plans for ‘s’. A set T⊆O is a PO-GSSS for ‘s’ if:
(i) T contains actions from a strongly optimal plan for s.
(ii) For every o∈T\O(s), T contains a NES for o.
(iii) For every o∈T∩O(s), T contains all o∈O that interfere with o in any state ‘s’∈S.
(iv) For every o∈T∩O(s), if o∈X, T contains all operators in X.

The system 202 may determine the one or more adapted stubborn sets based on the application of the modified definition of the GSSS. The one or more adapted stubborn sets may include a subset of actions that may be required to consider at any given state, while the rest can be temporarily ignored without affecting the optimality of the solution.

At 408, a pruned search space determination operation may be executed. In the pruned search space determination operation, the system 202 may determine a pruned search space based on the one or more adapted stubborn sets. The pruned search space may correspond to a reduced version of the original state space in the planning problem, which may be obtained by eliminating certain states and transitions that are deemed redundant for finding an optimal solution. This reduction may be achieved through techniques such as the one or more adapted stubborn sets. The goal of pruning the search space is to improve the efficiency of the search process by focusing computational resources on the most relevant parts of the state space. Details about the pruned search space are provided, for example, at 310 in FIG. 3

At 410, a solution determination operation may be executed. In the solution determination operation, the system 202 may determine a set of solutions that may be associated with the planning problem. The set of solutions may be determined based on the pruned search space. In an embodiment, the system 202 may execute a planner algorithm on the pruned search space. Based on the execution of the planner algorithm on the pruned search space, the system 202 may generate a set of solutions for the planning problem. Each solution of the set of solutions may include a set of plans that satisfies the cost constraints and successfully transitions from the initial state to the goal state. Specifically, each plan may include a sequence of actions to be followed to transition from the initial state to the goal state. In an embodiment, a cost associated with each plan of the set of plans may be less than the cost threshold that may be included in the first input.

In an embodiment, the planner algorithm may correspond to a K* planner algorithm. The K* algorithm may be an advanced heuristic search algorithm that may be designed to address complex planning problems that may have stringent cost constraints. The K* planner algorithm builds upon traditional heuristic search methods by incorporating a dynamic programming approach to systematically explore the pruned state space. Details about the K* planning algorithm are provided, for example, at 312 in FIG. 3.

At 412, a solution modification operation may be executed. In the solution modification operation, the system 202 may identify one or more duplicate plans in the set of plans. A plan may be deemed as a duplicate plan if the actions of the corresponding plan are the same as the actions in another plan and differ only in the sequence. Based on the identification of the one or more duplicate plans, the system 202 may remove the one or more duplicate plans from the set of plans to update the set of plans. Specifically, if there are 2 duplicate plans, then the system 202 may keep only the plan from the 2 duplicate plans in the updated set of plans.

At 414, a solution rendering operation may be executed. In the solution rendering operation, the system 202 may render the updated set of plans associated with the planning problem. In an embodiment, the system 202 may render the updated set of plans associated with the planning problem on the display screen 204 associated with the EUD 106. In another embodiment, the rendering of the set of solutions may correspond to the transmission of the set of solutions to an agent for the execution of the sequence of actions in the corresponding plan.

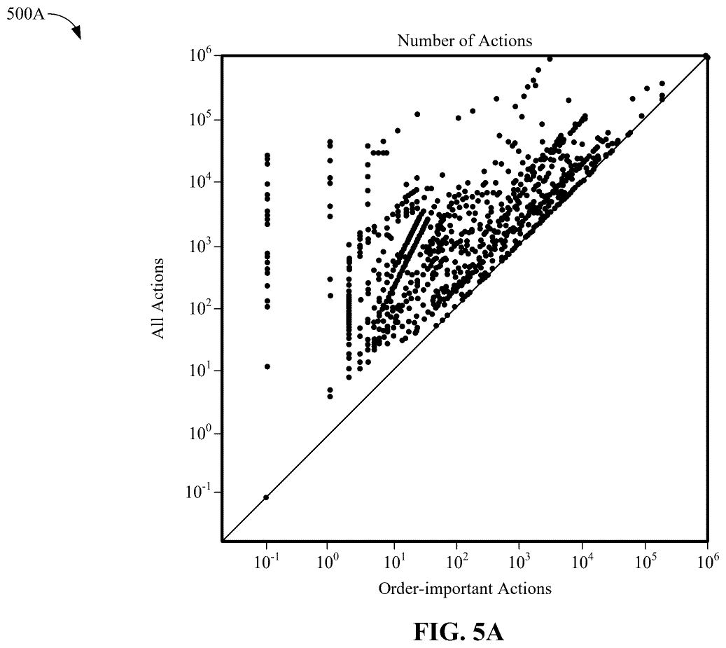

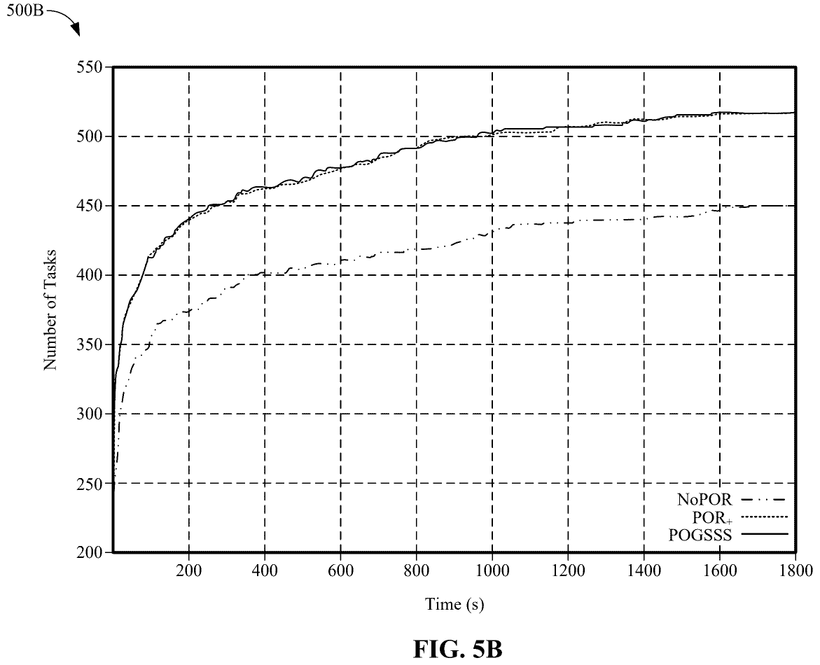

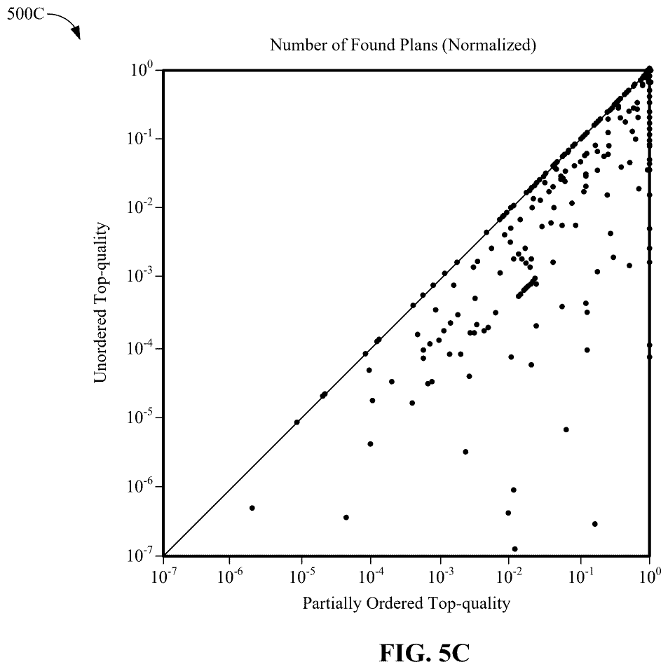

FIG. 5A, FIG. 5B, and FIG. 5C depict experimental evaluation results for the disclosed first method and second method for efficiently solving partially ordered top-quality planning, in accordance with an embodiment of the disclosure. FIG. 5A, FIG. 5B, and FIG. 5C are explained in conjunction with elements from FIG. 1, FIG. 2, FIG. 3, and FIG. 4. With reference to FIG. 5A, there is shown a first graph 500A. With reference to FIG. 5B, there is shown a second graph 500B, and with reference to FIG. 5C, there is shown a third graph 500C. The experimental evaluation results may be computed by any computing system, for example, by the computer 102 of FIG. 1 or the system 202 of FIG. 2.

To evaluate the disclosed first method (described in FIG. 3) and the second method first method (described in FIG. 4), the system 202 may execute the first method and the second method in addition to the K* planner algorithm and the Fast Downward planning system. The disclosed first method and the second method may be evaluated on standard test sets from International Planning Competitions (1998-2018), covering 52 different domains and a total of 1555 individual planning problems.

To evaluate the results, the system 202 compares three different methods that may include the first method described in FIG. 3, the second method described in FIG. 4, and a baseline method. As discussed above, the first method may extend the partial order reduction (POR) successor generator and may be referred to as POR+. The second method may modify the definition of the generalized strong stubborn sets and may be labelled as partial order generalized strong stubborn sets (PO-GSSS). The third method, which may be the baseline method, may execute a top-quality planner and post-process the plans to filter out equivalent plans. The third method may be labelled as No-partial order reduction (NoPOR). To improve efficiency and accuracy, advanced techniques like symmetry-based pruning and the LM-cut heuristic may be utilized in the determination of the experimental results. In our experiments, the system 202 may measure the coverage of solving the partially ordered top-quality planning problem for q=1, i.e., finding all non-equivalent cost-optimal plans.

FIG. 5A includes the first graph 500A that illustrates the relationship between the number of actions marked as “order-important” (on x-axis) and the total number of actions (on y-axis) across 1555 tasks. It shows that in 15 tasks, all actions are marked as “order-important”, represented by points lying on the diagonal. Conversely, in 37 tasks, none of the actions are marked as “order-important”. The spread of points on the plot indicates the varying degrees of order across different tasks, highlighting that for most tasks, only a subset of actions is deemed as “order-important”.

FIG. 5B includes the second graph 500B that illustrates the overall any-time coverage results, demonstrating how well different methods solve the tasks over time. Both the POR+ and PO-GSSS approaches exhibit very similar performance, significantly outperforming the baseline method that does not utilize partial order reduction. The full 30-minute coverage per domain may be detailed in Table 1, revealing that there are 15 domains where the coverage differs among the three methods.

TABLE 1
Per-domain coverage of the tested approaches.
The last row depicts the overall coverage

| Coverage | NoPOR | POR+ | POGSSS |
|---|---|---|---|
| airport (50) | 7 | 8 | 8 |
| driverlog (20) | 10 | 11 | 11 |
| movie (30) | 3 | 22 | 22 |
| mystery (30) | 20 | 22 | 22 |
| organic-synthesis-split18 (20) | 18 | 19 | 18 |
| parcprinter-08 (30) | 6 | 10 | 11 |
| parcprinter11 (20) | 3 | 6 | 7 |
| parking14 (20) | 2 | 3 | 2 |
| psr-small (50) | 46 | 48 | 48 |
| satellite (36) | 5 | 6 | 7 |
| snake18 (20) | 4 | 6 | 5 |
| termes18 (20) | 4 | 5 | 5 |
| tidybot14 (20) | 7 | 7 | 7 |
| woodworking08 (30) | 7 | 21 | 21 |
| woodworking11 (20) | 2 | 15 | 15 |
| Sum other (1139) | 307 | 307 | 307 |
| Sum (1555) | 450 | 516 | 516 |

Notably, the most significant improvements in coverage using partial order reduction are observed in the movie domain, where coverage increased from 3 to 22 tasks, and in the woodworking domain, where coverage increased from 7 and 2 to 21 and 15 tasks, respectively.

FIG. 5C includes the third graph 500C which compares the solution size (number of plans) of the partially ordered top-quality planning problem (on x-axis) with the unordered top-quality planning (on y-axis). Specifically, the third graph 500C compares the number of plans generated for the partially ordered top-quality planning problem against those generated for unordered top-quality planning. The comparison is normalized by the size of the full top-quality planning solution, fitting both values into a [0,1] range. Out of 325 tasks where all three values are available, 109 tasks have the same number of plans for both approaches, represented by points on the diagonal. For the remaining 216 tasks, the largest relative decrease in the number of plans was observed in the pathways domain, where the number of plans was reduced dramatically. This significant reduction highlights the effectiveness of incorporating partial order reduction in simplifying the solution space.

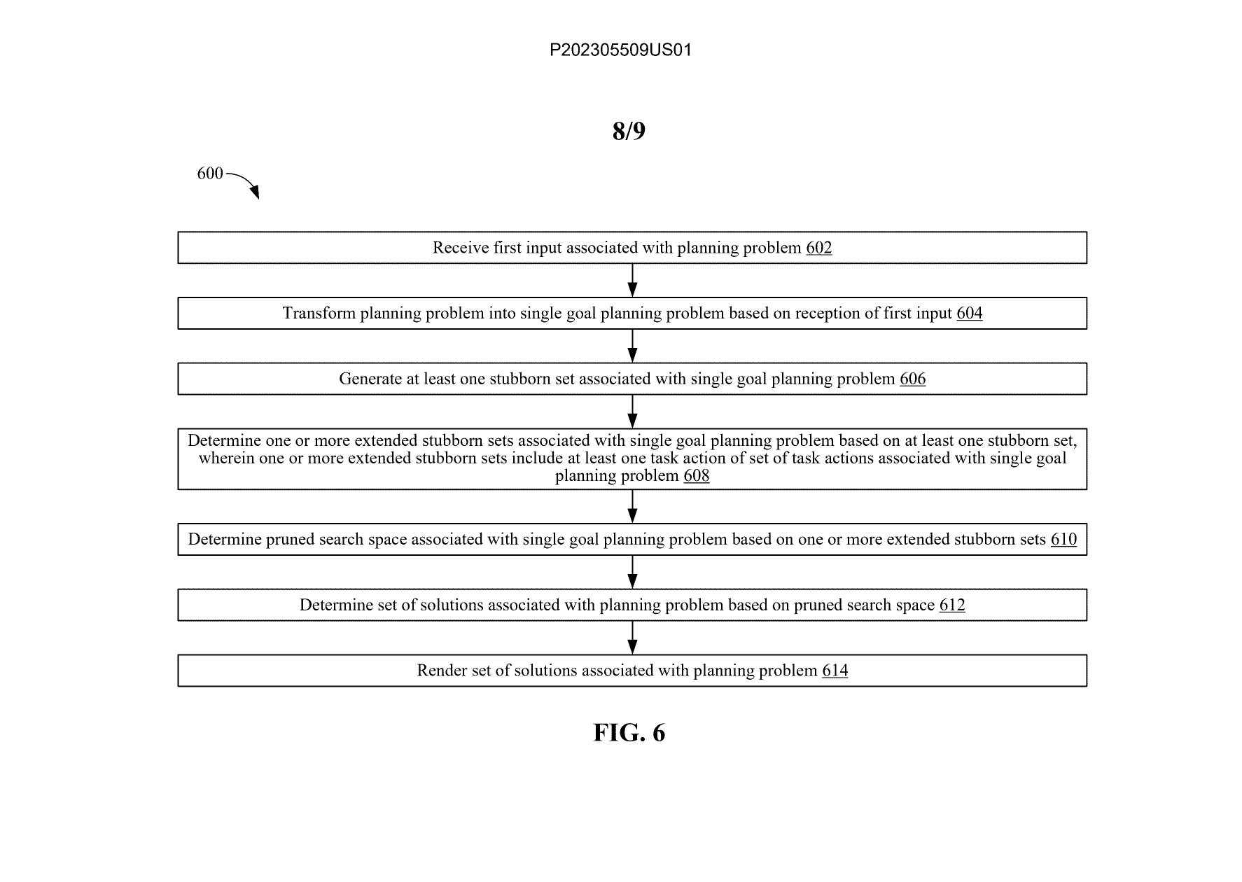

FIG. 6 is a flowchart that illustrates an exemplary first method for efficiently solving partially ordered top-quality planning, in accordance with an embodiment of the disclosure. FIG. 6 is explained in conjunction with elements from FIG. 1, FIG. 2, FIG. 3, FIG. 4, FIG. 5A, FIG. 5B, and FIG. 5C. With reference to FIG. 6, there is shown a flowchart 600. The operations of the exemplary method may be executed by any computing system, for example, by the computer 102 of FIG. 1 or the system 202 of FIG. 2. The operations of the flowchart 600 may start at 602.

At 602, the first input associated with the planning problem may be received. In an embodiment of the disclosure, the system 202 may receive the first input associated with the planning problem. Details about the first input associated with the planning problem are provided, for example, in FIG. 3, and FIG. 4.

At 604, the planning problem may be transformed into the single goal planning problem based on the reception of the first input. In an embodiment of the disclosure, the system 202 may transform the planning problem into the single goal planning problem based on the reception of the first input. Details about the single goal planning problem are provided, for example, in FIG. 3, and FIG. 4.

At 606, the at least one stubborn set associated with the single goal planning problem may be generated. In an embodiment of the disclosure, the system 202 may generate the at least one stubborn set associated with the single goal planning problem. Details about the stubborn set are provided, for example, in FIG. 3.

At 608, the one or more extended stubborn sets associated with the single goal planning problem may be determined based on at least one stubborn set. The one or more extended stubborn sets include at least one task action of the set of task actions associated with the single goal planning problem. In an embodiment of the disclosure, the system 202 may determine the one or more extended stubborn sets associated with the single goal planning problem based on the at least one stubborn set. The one or more extended stubborn sets include at least one task action of the set of task actions associated with the single goal planning problem. Details about the one or more extended stubborn sets are provided, for example, in FIG. 3.

At 610, the pruned search space associated with the single goal planning problem may be determined based on the one or more extended stubborn sets. In an embodiment of the disclosure, the system 202 may determine the pruned search space associated with the single goal planning problem based on the one or more extended stubborn sets. Details about the pruned search space are provided, for example, in FIG. 3 and FIG. 4.

At 612, the set of solutions associated with the planning problem may be determined based on the pruned search space. In an embodiment of the disclosure, the system 202 may determine the set of solutions associated with the planning problem based on the pruned search space. Details about the set of solutions associated are provided, for example, in FIG. 3, and FIG. 4.

At 614, the set of solutions associated with the planning problem may be rendered. In an embodiment of the disclosure, the system 202 may render the set of solutions associated with the planning problem. Control may pass to the end.

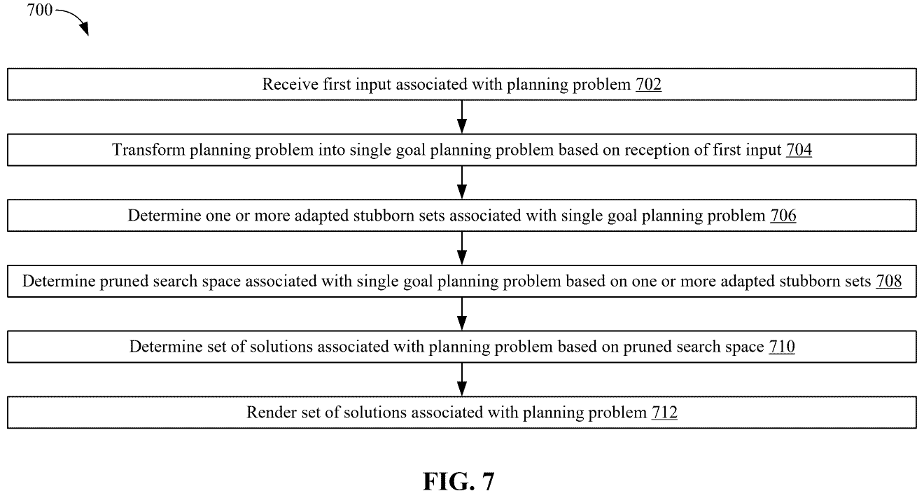

FIG. 7 is a flowchart that illustrates an exemplary second method for efficiently solving partially ordered top-quality planning, in accordance with an embodiment of the disclosure. FIG. 7 is explained in conjunction with elements from FIG. 1, FIG. 2, FIG. 3, FIG. 4, FIG. 5A, FIG. 5B, FIG. 5C, and FIG. 6. With reference to FIG. 7, there is shown a flowchart 700. The operations of the exemplary method may be executed by any computing system, for example, by the computer 102 of FIG. 1 or the system 202 of FIG. 2. The operations of the flowchart 700 may start at 702.

At 702, the first input associated with the planning problem may be received. In an embodiment of the disclosure, the system 202 may receive the first input associated with the planning problem. Details about the first input associated with the planning problem are provided, for example, in FIG. 3, and FIG. 4.

At 704, the planning problem may be transformed into the single goal planning problem based on the reception of the first input. In an embodiment of the disclosure, the system 202 may transform the planning problem into the single goal planning problem based on the reception of the first input. Details about the single goal planning problem are provided, for example, in FIG. 3, and FIG. 4.

At 706, the one or more adapted stubborn sets associated with the single goal planning problem may be determined. In an embodiment of the disclosure, the system 202 may determine the one or more adapted stubborn sets associated with the single goal planning problem. Details about the one or more adapted stubborn sets are provided, for example, in FIG. 4.

At 708, the pruned search space associated with the single goal planning problem may be determined based on the one or more adapted stubborn sets. In an embodiment of the disclosure, the system 202 may determine the pruned search space associated with the single goal planning problem based on the one or more adapted stubborn sets. Details about the pruned search space are provided, for example, in FIG. 3 and FIG. 4.

At 710, the set of solutions associated with the planning problem may be determined based on the pruned search space. In an embodiment of the disclosure, the system 202 may determine the set of solutions associated with the planning problem based on the pruned search space. Details about the set of solutions associated are provided, for example, in FIG. 3, and FIG. 4.

At 712, the set of solutions associated with the planning problem may be rendered. In an embodiment of the disclosure, the system 202 may render the set of solutions associated with the planning problem. Control may pass to the end.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, a first input associated with a planning problem;
transforming, by the computer, the planning problem into a single goal planning problem based on the reception of the first input;
generating, by the computer, at least one stubborn set associated with the single goal planning problem;
determining, by the computer, one or more extended stubborn sets associated with the single goal planning problem based on the at least one stubborn set, wherein the one or more extended stubborn sets comprises of at least one task action of a set of task actions associated with the single goal planning problem;
determining, by the computer, a pruned search space associated with the single goal planning problem based on the one or more extended stubborn sets;
determining, by the computer, a set of solutions associated with the planning problem based on the pruned search space; and
rendering, by the computer, the set of solutions associated with the planning problem.

2. The computer-implemented method of claim 1, wherein the first input comprises of a set of finite-domain state variables, a set of actions, an initial state, a goal state, a cost associated with each action of the set of actions, a cost threshold, and the set of task actions.

3. The computer-implemented method of claim 2, wherein the set of solutions corresponds to a set of plans, and wherein a cost associated with each plan of the set of plans is less than the cost threshold.

4. The computer-implemented method of claim 1, further comprising:
executing, by the computer, a planner algorithm based on the pruned search space; and
determining, by the computer, the set of solutions associated with the planning problem based on the execution of the planner algorithm.

5. The computer-implemented method of claim 4, wherein the set of solutions corresponds to a set of plans to be executed for solving the planning problem.

6. The computer-implemented method of claim 4, wherein the planner algorithm corresponds to a K* planner algorithm.

7. The computer-implemented method of claim 4, further comprising:
identifying, by the computer, one or more duplicate plans in the set of plans;
removing, by the computer, the one or more duplicate plans from the set of plans to update the set of plans; and
rendering, by the computer, the updated set of plans associated with the planning problem.

8. The computer-implemented method of claim 1, further comprising:
determining, by the computer, a time period associated with the determination of the set of solutions associated with the planning problem; and
rendering, by the computer, the time period, wherein the time period is indicative of a time taken for the determination of the set of solutions associated with the planning problem.

9. A system, comprising:
a processor set configured to:
receive a first input associated with a planning problem;
transform the planning problem into a single goal planning problem based on the reception of the first input;
determine one or more adapted stubborn sets associated with the single goal planning problem;
determine a pruned search space associated with the single goal planning problem based on the one or more adapted stubborn sets;
determine a set of solutions associated with the planning problem based on the pruned search space; and
render the set of solutions associated with the planning problem.

10. The system of claim 9, wherein the first input comprises of a set of finite-domain state variables, a set of actions, an initial state, a goal state, a cost associated with each action of the set of actions, a cost threshold, and a set of task actions.

11. The system of claim 10, wherein the set of solutions corresponds to a set of plans, and wherein a cost associated with each plan of the set of plans is less than the cost threshold.

12. The system of claim 9, wherein the processor set is further configured to:
execute a planner algorithm based on the pruned search space; and
determine the set of solutions associated with the planning problem based on the execution of the planner algorithm.

13. The system of claim 12, wherein the planner algorithm corresponds to a K* planner algorithm.

14. The system of claim 10, wherein the set of solutions corresponds to a set of plans to be executed for a solution of the planning problem.

15. The system of claim 14, wherein the processor set is further configured to:
identify one or more duplicate plans in the set of plans;
remove the one or more duplicate plans from the set of plans to update the set of plans; and
render the updated set of plans associated with the planning problem.

16. The system of claim 15, wherein the processor set is further configured to:
determine a time period associated with the determination of the set of solutions associated with the planning problem; and
render the time period, wherein the time period is indicative of a time taken for the determination of the set of solutions associated with the planning problem.

17. A computer program product solving partially ordered top-quality planning, the computer program product comprising a computer-readable storage medium having program instructions embodied therewith, the program instructions executable by a system to cause the system to:
receive a first input associated with a planning problem;
transform the planning problem into a single goal planning problem based on the reception of the first input;
generate at least one stubborn set associated with the single goal planning problem;
determine one or more extended stubborn sets associated with the single goal planning problem based on the at least one stubborn set, wherein the one or more extended stubborn sets comprises of at least one task action of a set of task actions associated with the single goal planning problem;
determine a pruned search space associated with the single goal planning problem based on the one or more extended stubborn sets;
determine a set of solutions associated with the planning problem based on the pruned search space; and
render the set of solutions associated with the planning problem.

18. The computer-readable storage medium of claim 17, wherein the first input comprises of a set of finite-domain state variables, a set of actions, an initial state, a goal state, a cost associated with each action of the set of actions, a cost threshold, and a set of task actions.

19. The computer-readable storage medium of claim 18, wherein the set of solutions corresponds to a set of plans, and wherein a cost associated with each plan of the set of plans is less than the cost threshold.

20. The computer-readable storage medium of claim 17, wherein the program instructions executable by the system to cause the system to:
execute a planner algorithm based on the pruned search space; and
determine the set of solutions associated with the planning problem based on the execution of the planner algorithm.
